(19) United States
(12) Patent Application Publication
(10) Pub. No.: US 2004/0018906 A1
(43) Pub. Date: Jan. 29, 2004

(54) Belt

(76) Inventor: Douglas R. Sedlacek, Englewood, CO (US)

Correspondence Address: Jeffrey Thurnau, The Gates Corporation, Mail Stop 31-4-1-A3, 900 S. Broadway, Denver, CO, 80209, US

(21) Appl. No.: 10/619,803

(22) Filed: Jul. 14, 2003

Related U.S. Application Data
(60) Provisional application No. 60/399,512, filed on Jul. 29, 2002.

(51) Int. Cl. F16G 1/00; F16G 5/00

(52) U.S. Cl. 474/260

(57) ABSTRACT

A belt having an elastomeric body and tensile cords. The belt comprises a rib or ribs extending in an endless direction. A polyethylene layer is attached to each rib tip to change a coefficient of friction.

### REFERENCE TO RELATED APPLICATIONS

This application claims priority from U.S. provisional application No. 60/399,512 filed Jul. 29, 2002.

### FIELD OF THE INVENTION

The invention relates to a belt and more particularly, to a belt having a polyethylene layer applied to a rib tip to minimize a pulley engagement noise and improve stability.

### BACKGROUND OF THE INVENTION

V-ribbed power transmission belts generally operate in rotating pulleys. The belt engages and disengages from each pulley during each rotation. Each engagement process includes a movement of the belt into a pulley groove having a radial component. Such radial component results in the belt partially sliding into a pulley groove. Noise can be caused by such sliding engagement as a rib edge engages the sides of the pulley groove.

Frictional modifiers are known in the art to minimize noise. Frictional modifiers can include additives such as waxes, oils, graphite, molybdenum disulfide, PTFE, mica, talc, fibers and various blends and equivalents thereof. These additives are each added to the rubber compound during manufacturing. Each of these is added to the belt body elastomeric during compounding, resulting in portions of the body having frictional modifiers where no frictional modifiers are required. This adds complexity and cost to the belt manufacturing process.

Application of a layer to a tooth crest is known. However, the material comprises fabric and is used to strengthen each tooth. The fabric is not used as a frictional modifier, although it may reduce friction. However, it may produce the undesirable effect of stiffening the belt, and/or increasing running temperature thereby decreasing belt life.

Representative of the art is U.S. Pat. No. 4,011,766 (1977) to Waugh which discloses a fabric layer defining a crest of a tooth.

Reference is also made to copending U.S. application Ser. No. 10/121,556 filed Apr. 12, 2002 which discloses a toothed belt having a UHMWPE jacket.

It is desirable to have a frictional modifier which only need be applied to the part of the belt needing such. What is needed is a belt having a thermoplastic material attached to a rib tip to minimize a pulley engagement noise. What is needed is a belt having polyethylene attached to a rib tip to reduce a pulley engagement noise. The present invention meets these needs.

### SUMMARY OF THE INVENTION

The primary aspect of the present invention is to provide a belt having a thermoplastic material attached to a rib tip to minimize a pulley engagement noise.

Another aspect of the invention is to provide a belt having polyethylene attached to a rib tip to reduce a pulley engagement noise.

Other aspects of the invention will be pointed out or made apparent by the following description of the invention and the accompanying drawings.

The invention comprises a belt having an elastomeric body and tensile cords. The belt comprises a rib or ribs extending in an endless direction. A polyethylene layer is attached to each rib tip to change a coefficient of friction.

### BRIEF DESCRIPTION OF THE DRAWINGS

FIG. 1 is a cross sectional view of an inventive belt.

FIG. 2 is a cross sectional view of an alternate embodiment.

### DETAILED DESCRIPTION OF THE INVENTION

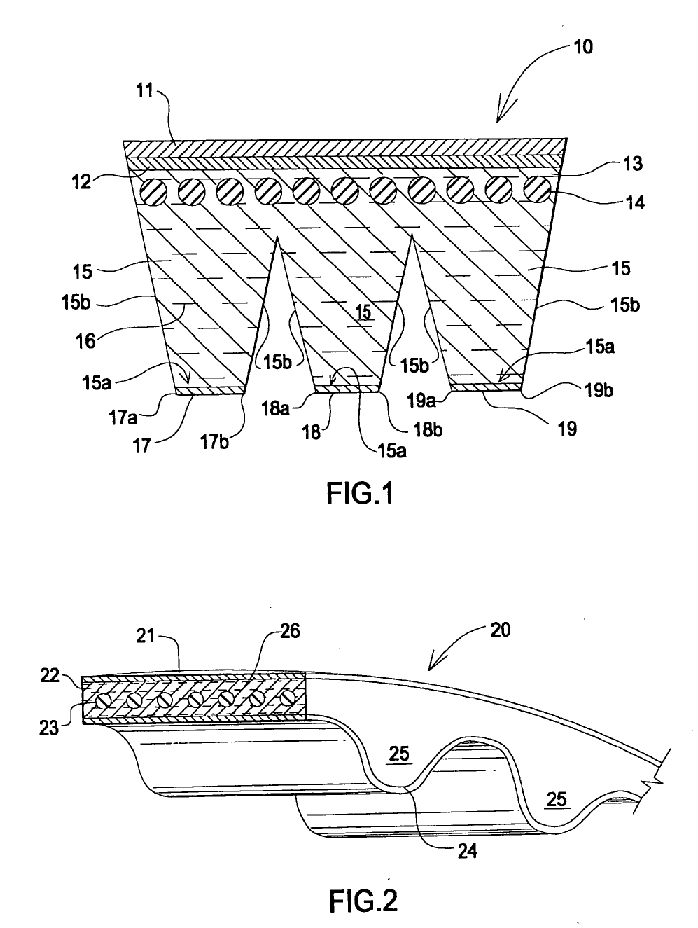

FIG. 1 is a cross sectional view of an inventive belt. Belt 10 comprises a v-belt or multi-ribbed v belt. A multi-ribbed v-belt is depicted having ribs 15; although the belt may comprise a single rib 15 as well.

Belt 10 comprises an elastomeric body 13 with tensile members or cords 14 embedded therein. The tensile members 14 extend parallel to a longitudinal axis. Tensile members 14 may comprise any material known in the belt art, including polyester, nylon, aramid and their equivalents, or a combination of two or more.

A profile comprises ribs 15 extending parallel to an endless direction of the belt body 13.

Fibers 16 are embedded in the matrix of the elastomeric body 13 and ribs 15. Fibers 16 decrease rib surface sloughing and chatter. The fibers may include aramid, carbon, polyester, polyethylene, fiberglass, nylon and blends and equivalents thereof. Other organic fibers may include wool, silk, hemp, cotton, and blends and equivalents thereof. The amount of fibers used in the rib elastomeric may be in the range of approximately 0.01 to 40 parts fiber per hundred parts of rubber (PHR). The present embodiment utilizes approximately 22 parts cotton fiber per hundred parts of rubber. The fibers have a diameter in the range of approximately 0.016 mm to 0.021 mm and a length in the range of approximately 0.0+ to 6 mm. The inventive belt may also be manufactured without use of fibers 16 embedded in the elastomeric body.

Layers 11, 12 comprise a thermoplastic material. By way of example and not of limitation, each layer 11, 12 may also substantially comprise polyethylene, polypropylene, polyester, polyamide, polyvinylidene chloride and any equivalents or combinations thereof. Thermoplastic layer 12 is joined to body 13 by use of any suitable cure, chemical adhesive or molding process known in the art. Although the preferred embodiment uses a peroxide cure process, thermoplastic layer 12 may also be joined to body 13 using chemical adhesives known in the art, as well as by molding. In the case of polyethylene, layer 11, 12, are each compatible with and co-curable with ethylene propylene rubbers via peroxide cure. The polyethylene used in the disclosed embodiment has a molecular weight up to approximately 250,000 g/mole.

Body 13 and ribs 15 may comprise thermoset elastomeric material such as EPDM (ethylene-propylene diene rubber), HNBR (hydrogenated acrylonitrile-butadiene rubber), PU (polyurethane), CR (chloroprene rubber), SBR (styrene-butadiene rubber), NBR (nitrile rubber), plus any equivalents or combinations of two or more of the foregoing, or, any other elastomeric material used in power transmission belts to which thermoplastic material may be attached.

Layer portion 17, 18, 19 are each attached to a rib tip 15a. Each layer portion 17, 18, 19 acts as a frictional modifier to minimize an engagement noise between the belt and a pulley groove, particularly in situations of pulley misalignment. Each of layer portions 17, 18, 19 may, by way of example and not of limitation, comprise polyethylene, polypropylene, polyester, polyamide, polyvinylidene chloride and any equivalents or combinations thereof. Layer portions 17, 18, 19 are each initially joined to the portion which will become each rib 15 as a single layer during fabrication of the belt by use of any suitable cure, chemical adhesive or molding process known in the art. Although the preferred embodiment uses a peroxide cure process, layer portions 17, 18, 19 may each also be joined to belt 10 and rib 15 using chemical adhesives known in the art and by molding. In the case of polyethylene, layer portions 17, 18, 19 are compatible with and co-curable with ethylene propylene rubbers via peroxide cure. The polyethylene used in the disclosed embodiment has a molecular weight up to approximately 250,000 g/mole.

Belt 10 is manufactured using methods known in the art. Each of the layers of the belt is laid up on a mandrel and cured. Once cured the belt is cut or ground to the final multi-ribbed or v-belt profile. A single thermoplastic layer is ground or cut during formation of the rib or ribs, thereby forming layer portions 17, 18, 19 on the tip 15a of each rib 15.

Since the belt profile is ground or cut, rib sides 15b have no layer covering and instead only comprise an exposed portion of the elastomeric belt body 13. As a result, the torque carrying capacity of the belt is not affected.

In operation, the inventive belt minimizes or eliminates noise associated with engagement of the belt with a pulley groove. Each layer portion 17, 18, 19 has a coefficient of friction lass than that of the elastomeric material of which ribs 15 are comprised, thereby allowing each rib initial ease of engagement with a pulley groove.

More particularly, an edge of each layer portion 17a, 17b, 18a, 18b, 19a, 19b, each attached to a respective rib edge, come into initial contact with a pulley groove. As the belt further engages the pulley, layer portion edges 17a, 17b, 18a, 18b, 19a, 19b allow each rib to slide into a pulley groove without noise. Such noise is otherwise caused by the rib edge elastomeric material having a stick-slip engagement with each pulley groove.

The inventive belt has successfully demonstrated noiseless operation for multi-ribbed pulley misalignments of up to approximately 3°. Pulley misalignment is the measure of an angular difference between the planes of two pulleys upon which the belt is trained. When a polyethylene layer portion 17 is present on a single rib belt, for example, it minimizes a tendency of the single rib v-belt to ‘roll’ out of a single pulley groove. In cases of extreme misalignment this is caused by engagement of the rib edge with a pulley edge. Prior art single rib belts have a tendency to roll out of a pulley groove when misalignment exceeds approximately 4.5°. However, the inventive belt will not roll out of a pulley groove until the misalignment exceeds approximately 5.5°, an increase of approximately 22%.

FIG. 2 is a cross sectional view of an alternate embodiment. Belt 20 has a toothed profile and as such may be suitable for use in a synchronous belt drive, for example. Belt 20 comprises tensile members or cords 23 embedded in elastomeric belt body 22. Tensile cords 23 extend in an endless direction and comprise the same materials as described for tensile members 14 herein. Teeth 25 extend transversely to a belt length. Fibers 26 are embedded within the belt body 22. Belt body 22 comprises the same materials as described for belt body 13 herein.

Overcord layer 21 is attached to the top of the belt. Undercord layer 24 is attached to the teeth. Layers 21 and 24 each comprise by way of example and not of limitation, polyethylene, polypropylene, polyester, polyamide, polyvinylidene chloride and any equivalents or combinations thereof. Layers 21, 24 are each joined to the belt during fabrication by use of any suitable cure, chemical adhesive or molding process known in the art. Although the preferred embodiment uses a peroxide cure process, layers 21, 24 may also be attached to belt 20 using chemical adhesives known in the art and by molding. In the case of layers 21, 24, comprising polyethylene, each is compatible with and co-curable with ethylene propylene rubbers via peroxide cure. The polyethylene used in the disclosed embodiment has a molecular weight up to approximately 250,000 g/mole. Layers 21, 24 may also comprise different materials as between each layer, for example, layer 21 may comprise polyester while layer 24 comprises polyethylene. Other combinations of layer materials are possible as well.

Although forms of the invention have been described herein, it will be obvious to those skilled in the art that other variations may be made in the construction and relation of parts without departing from the spirit and scope of the invention described herein.

I claim:

1. A belt comprising:
an elastomeric body;
a tensile member extending along the belt in a longitudinal direction;
the body having a rib extending in an endless direction; and
a thermoplastic layer attached to the rib.

2. The belt as in claim 1, wherein the thermoplastic layer is selected from polyethylene, polypropylene, polyester, polyamide, polyvinylidene chloride or a combination of any two or more of the foregoing.

3. The belt as in claim 2, wherein the elastomeric body is selected from HNBR, EPDM, SBR, NBR, PU, CR or a combination of any two or more of the foregoing.

4. The belt as in claim 3, wherein the thermoplastic layer is applied to a rib edge.

5. The belt as in claim 4 further comprising a plurality of ribs.

6. The belt as in claim 3, wherein the thermoplastic material is attached to a rib tip.

7. A belt comprising:
an elastomeric body;
a tensile member extending along the belt in a longitudinal direction;
the body having a rib extending in an endless direction; and
a member attached to a rib edge.

8. The belt as in claim 7, wherein the member is selected from polyethylene, polypropylene, polyester, polyamide, polyvinylidene chloride or a combination of any two or more of the foregoing.

9. The belt as in claim 8, wherein the elastomeric body is selected from HNBR, EPDM, SBR, NBR, PU, CR or a combination of any two or more of the foregoing.

10. The belt as in claim 9 further comprising a plurality of ribs.

11. The belt as in claim 9 further comprising fibers.

12. A belt comprising:
an elastomeric body;
a tensile member extending along the belt in a longitudinal direction;
the body having teeth, the teeth oriented transverse to an endless direction; and
a thermoplastic layer attached to the teeth.

13. The belt as in claim 12, wherein the thermoplastic layer is selected from polyethylene, polypropylene, polyester, polyamide, polyvinylidene chloride or a combination of any two or more of the foregoing.

14. The belt as in claim 3, wherein the elastomeric body is selected from HNBR, EPDM, SBR, NBR, PU, CR or a combination of any two or more of the foregoing.
